(19) United States
(12) Patent Application Publication
(10) Pub. No.: US 2025/0218061 A1
(43) Pub. Date: Jul. 3, 2025

(54) IMAGE GENERATION WITH LEARNED SUPERVISION

(71) Applicant: Shutterstock, Inc., New York, NY (US)

(72) Inventors: Raúl Gómez Bruballa, Dublin (IE); Alessandra Sala, Dublin (IE)

(21) Appl. No.: 19/005,067

(22) Filed: Dec. 30, 2024

Related U.S. Application Data
(60) Provisional application No. 63/615,420, filed on Dec. 28, 2023.

(51) Int. Cl. G06T 11/00

(52) U.S. Cl. CPC G06T 11/00

(57) ABSTRACT

A method for training a generative image model includes providing, to the generative image model, an image caption associated with input image data, receiving, from the generative image model, output image data, providing the output image data to an image scoring model that scores images according to image quality based on an image quality metric, receiving image quality data associated with the output image data from the image scoring model, the image quality data characterizing image quality of the output image data according to the image quality metric, using a loss function, computing a loss based on at least the output image data and the image quality data, and using the loss, conditioning the generative image model to generate images with high image quality according to the image quality metric.

### CROSS-REFERENCE OF RELATED APPLICATION

This application claims the benefit of U.S. Provisional Application No. 63/615,420, filed on Dec. 28, 2023, and which is incorporated herein in its entirety.

### TECHNICAL FIELD

The present disclosure generally relates to image generation, and more particularly to image generation refinement with learned supervision.

### BACKGROUND

Generative artificial intelligence (AI) has been used for image generation using a text-based prompt. However, generating higher quality images requires human supervision to annotate and rank images generated by various models. The requirement of human supervision increases cost and constrains the training of these image generation models.

Accordingly, there is a need for reducing or eliminating the need for human supervision of training of image generation models.

### SUMMARY

Some embodiments of the present disclosure provide a method for training a generative image model. The method provides, to the generative image model, an image caption associated with input image data, and receives, from the generative image model, output image data. The method further provides the output image data to an image scoring model that scores images according to image quality based on an image quality metric, and receives image quality data associated with the output image data from the image scoring model, the image quality data characterizing image quality of the output image data according to the image quality metric. Using a loss function, the method further computes a loss based on at least the output image data and the image quality data, and using the loss, optimizes the generative image model to generate images with high image quality according to the image quality metric.

Some embodiments of the present disclosure provide a non-transitory computer-readable medium storing a program for training a generative image model. The program, when executed by a computer, configures the computer to provide, to the generative image model, an image caption associated with input image data, and to receive, from the generative image model, output image data. The program, when executed by the computer, further configures the computer to provide the output image data to an image scoring model that scores images according to image quality based on an image quality metric, and to receive image quality data associated with the output image data from the image scoring model, the image quality data characterizing image quality of the output image data according to the image quality metric. Using a loss function, the program, when executed by the computer, further configures the computer to compute a loss based on at least the output image data and the image quality data, and using the loss, to optimize the generative image model to generate images with high image quality according to the image quality metric.

Some embodiments of the present disclosure provide a system for training a generative image model. The system comprises a processor and a non-transitory computer readable medium storing a set of instructions, which when executed by the processor, configure the processor to provide, to the generative image model, an image caption associated with input image data, and to receive, from the generative image model, output image data. The instructions, when executed by the processor, further configure the computer to provide the output image data to an image scoring model that scores images according to image quality based on an image quality metric, and to receive image quality data associated with the output image data from the image scoring model, the image quality data characterizing image quality of the output image data according to the image quality metric. Using a loss function, the instructions, when executed by the processor, further configure the computer to compute a loss based on at least the output image data and the image quality data, and using the loss, to optimize the generative image model to generate images with high image quality according to the image quality metric.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement image generation, according to some embodiments.

FIG. 2 is a block diagram illustrating details of a system for image generation, according to some embodiments.

FIG. 3 is a block diagram that illustrates a training pipeline for training an image generation model, according to some embodiments.

FIG. 4 is a block diagram that illustrates a training pipeline for training an image scoring model, according to some embodiments.

FIG. 5 is a block diagram that illustrates a training pipeline for refining an image scoring model, according to some embodiments.

FIG. 6 is a flowchart illustrating a process for training a generative image model, according to some embodiments.

FIG. 7 is a block diagram illustrating an exemplary computer system with which aspects of the subject technology can be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The term “image generation model” as used herein refers, in some embodiments, to artificial intelligence-based (AI) and/or machine learning (ML) models designed to generate image output based on text, image, audio, video, or other digital media inputs. These models employ various techniques including, but not limited to, diffusion models, latent diffusion models, generative adversarial networks (GANs), variational autoencoders (VAEs), autoregressive models, and transformer-based architectures. The terms “image generator” and “generative image model” may be used equivalently herein to refer to image generation models. As used herein, image generation models are also understood by persons of ordinary skill in the art to include video generative models that generate video output.

The term “loss function” as used herein refers, according to some embodiments, to mathematical functions that are used in the training of image generation models. These functions quantify the discrepancy between the model's predictions and the ground truth (i.e., the training data) to guide an iterative optimization process, enabling the trained model to generate accurate and diverse output images. Examples of loss functions for image generation models include, but are not limited to, mean squared error (MSE), cross-entropy, Wasserstein distance, and Kullback-Leibler (KL) divergence. The term “reconstruction loss” may be used herein to refer to the discrepancy between the model's predictions and the ground truth during a single iteration of the training process.

The term “optimization loss” as used herein refers, according to some embodiments, to an overall objective of minimizing the discrepancy being measured by the loss function to improve the model's performance. In other words, the loss function evaluates individual predictions and guiding model adjustments, and the optimization loss seeks to minimize error across the entire training dataset, by iteratively adjusting model parameters during training.

All references cited anywhere in this specification, including the Background and Detailed Description sections, are incorporated by reference as if each had been individually incorporated.

Some embodiments provide a technique to train an image generation model, or to refine a pre-trained image generation model, by leveraging image quality scores. The base generative model may be any image generation model, such as but not limited to an artificial intelligence (AI) image generator or a machine learning (ML) image generator. Examples of artificial intelligence image generation models include, but are not limited to, generative adversarial networks (GANs), variational autoencoders (VAEs), autoregressive models, diffusion models, and latent diffusion models (e.g., Stable Diffusion).

In some embodiments, an image scoring model may be trained to score images based on an image quality metric (e.g., engagement scores, ratings, and the like). For example, image quality may be represented by image quality scores. Examples of image scores include, but are not limited to, scores provided by human annotators, scores coming from image engagement data in an online platform, or scores computed based on arbitrary image properties. Scores may indicate how photorealistic an image is, or represent other image values, such as how professional an image looks, how likely it is to appear in an ad, or how inspiring it is for a certain group of people. Generally, image quality scores may be any desired metric. In some embodiments, image quality scores may also be based on profiles, preferences, and/or attributes of a user or a plurality of users (e.g., a demographic).

In some embodiments, the image generation model may be fine-tuned to push image generation towards higher scoring images. The fine-tuning may be implemented using different techniques, such as gradients propagated from the image scoring model, or in a ranking fashion, where several images are generated, scored, and the image generation model is updated to generate the highest scoring image.

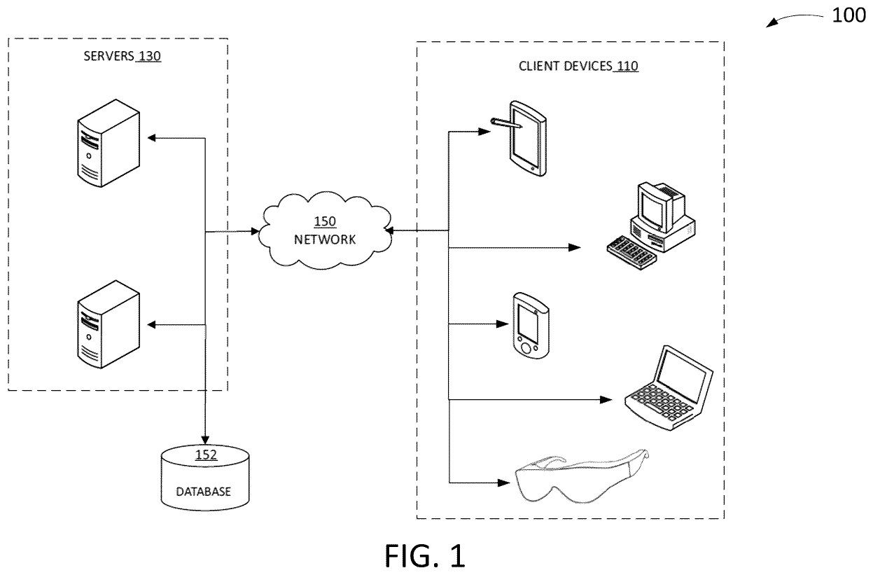

FIG. 1 illustrates a network architecture 100 used to implement image generation, according to some embodiments. The network architecture 100 may include one or more client devices 110 and servers 130, communicatively coupled via a network 150 with each other and to at least one database, e.g., database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

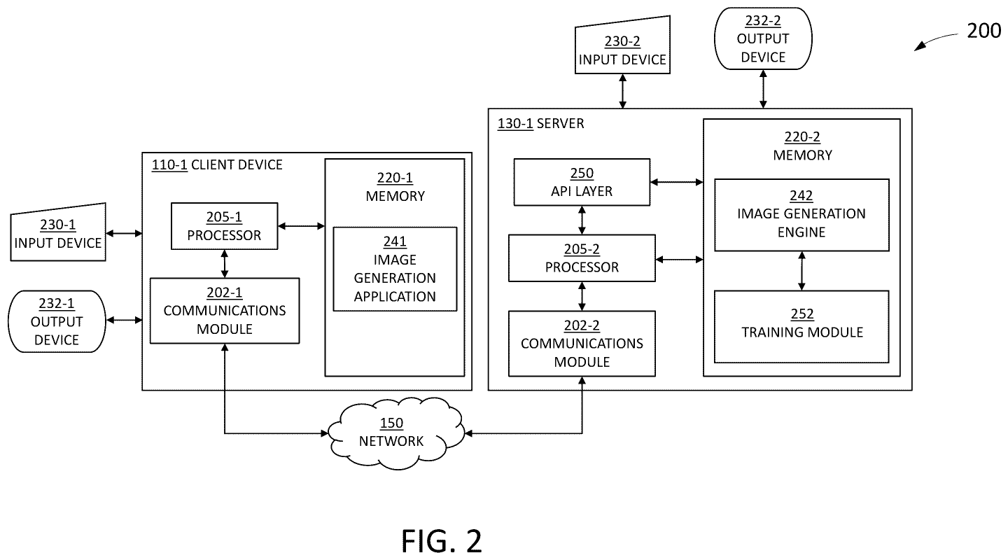

FIG. 2 is a block diagram illustrating details of a system 200 for image generation, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include processors 205-1 and 205-2 and memories 220-1 and 220-2, respectively. Processors 205-1 and 205-2 and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232. In some embodiments, the processor 205-1 is configured to control a graphical user interface (GUI) spanning at least a portion of input devices 230 and output devices 232, for the user of client device 110-1 to access the server 130-1.

Memory 220-1 may further include an image generation application 241, configured to execute on client device 110-1 and couple with input device 230-1 and output device 232-1. The image generation application 241 may be downloaded by the user from server 130-1, and/or may be hosted by server 130-1. The image generation application 241 may include specific instructions which, when executed by processor 205-1, cause operations to be performed consistent with embodiments of the present disclosure. In some embodiments, the image generation application 241 runs on an operating system (OS) installed in client device 110-1. In some embodiments, image generation application 241 may run within a web browser.

In some embodiments, memory 220-2 includes an image generation engine 242. The image generation engine 242 may include one or more image generation models that may be configured to perform methods and operations consistent with embodiments of the present disclosure. The image generation engine 242 may share or provide features and resources with the client device 110-1, including data, libraries, and/or applications retrieved with image generation engine 242 (e.g., image generation application 241). The user may access the image generation engine 242 through the image generation application 241. The image generation application 241 may be installed in client device 110-1 by the image generation engine 242 and/or may execute scripts, routines, programs, applications, generative image models, and the like provided by the image generation engine 242. In some embodiments, image generation application 241 may communicate with image generation engine 242 through an API layer 250.

In some embodiments, memory 220-2 includes training module 252. The training module 252 may be configured to perform methods and operations consistent with embodiments of the present disclosure. For example, training module 252 may perform a training process on one or more image generation models executed by the image generation engine 242. The training module 252 may use training data (not shown) either stored in memory 220-2 or retrieved from an external database (e.g., database 152) to perform the training process on the image generation models.

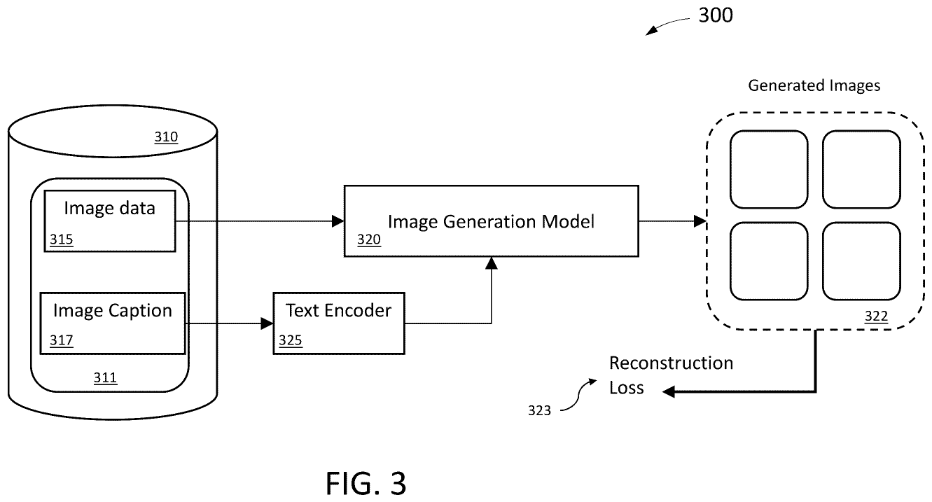

FIGS. 3 to 5 provide an illustration of various stages of training an image generator and refining the trained image generator with image scores, according to some embodiments. In various embodiments, some of these stages may be combined, or omitted.

In some embodiments, the first stage is to train an image generation model. Once trained, the image generation model may be capable of generating an image given any input prompt. Generation of images using the trained model may be referred to as inference. The input prompt may be text in some embodiments, and in other embodiments, image generation may occur using models that generate an image given an input sketch, shape, and/or another image, in addition to a text prompt or even without requiring a text prompt. In still other embodiments, image transformation may occur with a generative model that applies a transformation to an input image, without requiring an input of any other data type, though additional data inputs may be optional. This stage may be omitted if a pre-trained model is used.

FIG. 3 is a block diagram that illustrates a training pipeline 300 for training an image generation model, according to some embodiments. In the example of FIG. 3, the training pipeline 300 uses general training data 310 having multiple training images, of which an exemplary training image 311 is shown in more detail. The training image 311 includes image data 315 and an associated image caption 317. The image caption 317 may be stored as metadata tags (e.g., as entries within a header structure) of the image data 315, stored alongside the image data 315 in a same storage, or retrieved from an external database (e.g., database 152, according to some embodiments).

The general training data 310 may be used to train an image generation model 320. The image generation model 320 may be a baseline image generation model that has not undergone any previous iterations of training or conditioning, or a pre-trained image generation model that has already undergone at least one iteration of training and/or conditioning.

Using at least the image caption 317 as an input, the image generation model 320 outputs one or more generated images 322, which are then compared to the ground truth (e.g., image data 315) using a loss function (not shown). A reconstruction loss 323 is computed using the loss function and used to optimize the variables of the image generation model 320. This training process is repeated until the reconstruction loss 323 is below a certain threshold or meets other stopping criteria (e.g., using various image-based and/or quantitative metrics).

The reconstruction loss 323 (also referred to as an optimization loss) may be calculated by various methods, including but not limited to image subtraction in pixel space, a vector difference in a vector representation space, a matrix difference, and the like. The training process optimizes the image generation model 320 to generate target images based on an image prompt (corresponding to image captions such as image caption 417). In some embodiments, the image generation model 320 may be conditioned on different types of information, i.e., a sketch, another image, etc., during the current training process, an earlier training process, or combination thereof.

During training, the image captions may need to be encoded and/or embedded so that it can be consumed by the image generation model being trained. In some embodiments, as illustrated with the example of FIG. 3, the image captions may be encoded using a text encoder 325. As a non-limiting example, the text encoder 325 may be a large language model.

The image generation model 320 may be one of a Generative Adversarial Network (GAN), a Variational Autoencoder (VAE), an autoregressive model, a diffusion-based model, a transformer-based architecture, or other type of generative model. The image generation model 320 may be a generative model of a different modality, such as a video generation model. Furthermore, the image generation model 320 may already be optimized and/or conditioned to various features in the general training data 310.

In some embodiments, the second stage is to train an image scoring model. The image scoring model may be optimized towards high quality images, where quality is quantified by image scores. For example, the image scoring model may be trained using a strategy to infer scores from image pixels, as optimized with a regression loss. The image scoring model may also be trained to infer scores from other image features (features extracted by other models, geometric features, or additional image metadata). Furthermore, the image scoring model may be trained with other strategies, such as in a classification or a contrastive setup.

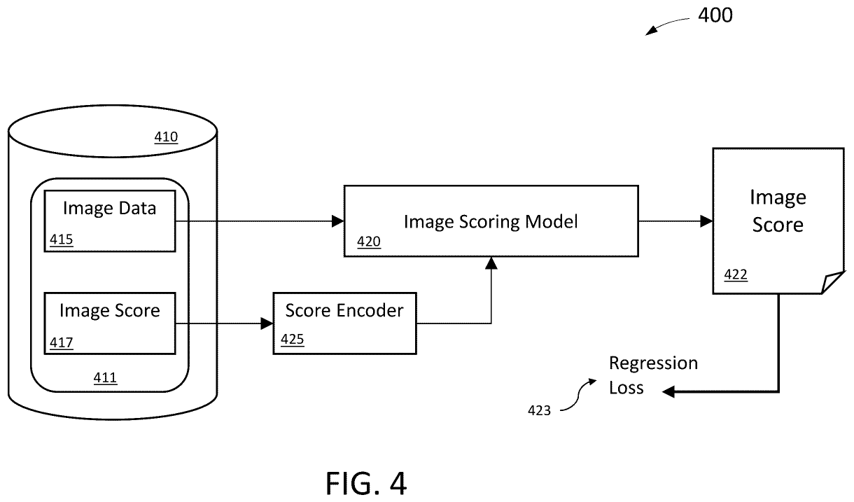

FIG. 4 is a block diagram that illustrates a training pipeline 400 for training an image scoring model, according to some embodiments. The training pipeline 400 is similar to the embodiment of the training pipeline 300 discussed above with respect to FIG. 3, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

In the example of FIG. 4, the training pipeline 400 uses training data 410 having multiple training images, of which an exemplary training image 411 is shown in more detail. The training image 411 includes image data 415 and an associated image score 417. The image score 417 may be stored as metadata tags (e.g., as entries within a header structure) of the image data 415, stored alongside the image data 415 in a same storage, or retrieved from an external database (e.g., database 152, according to some embodiments).

The image score 417 may be associated with the image data 415 from a manual scoring process or an automated scoring process. In some embodiments, the image score 417 may be automatically applied using a classification process, a scoring model, or other scoring system. In various embodiments, the image score 417 may be a quantitative score (e.g., a number within a range, such as zero to ten, or any other range), a symbolic rating (e.g., an emoji, a number of stars, or the like), or a qualitative rating (e.g., a thumbs up or down, or the like).

In some embodiments, the image scores comprise engagement data of images from a social media platform. Engagement data may include, but is not limited to, clicks, views, likes, saves, downloads, favorites, shares, remixes, and the like. The image score 417 may be, for example, a quantitative measurement of one or more such engagement metrics.

In some embodiments, the image scores comprise usage data of images from a stock image database. Usage data may include, but is not limited to, searches, views, favorites, saves, downloads, purchases, resolutions, and the like.

The general training data 410 may be used to train an image scoring model 420. The image generation model 420 may be a baseline image scoring model that has not undergone any previous iterations of training or conditioning, or a pre-trained image scoring model that has already undergone at least one iteration of training and/or conditioning.

Using at least the image data 415 as an input, the image scoring model 420 outputs an image score 422, which is then compared to the ground truth (e.g., image score 417) using a loss function (not shown). A regression loss 423 is computed using the loss function and used to optimize the variables of the image scoring model 420. This training process is repeated until the regression loss 423 is below a certain threshold or meets other stopping criteria (e.g., using various image-based and/or quantitative metrics).

The regression loss 423 (also referred to as an optimization loss) may be calculated by various methods, including but not limited to a vector difference in a vector representation space, a matrix difference, and the like. The training process optimizes the image scoring model 420 to score target images.

During training, the image scores may need to be encoded and/or embedded so that it can be consumed by the image scoring model being trained. In some embodiments, as illustrated with the example of FIG. 4, the image scores may be encoded using a score encoder 425. As a non-limiting example, the score encoder 425 may be a large language model.

In some embodiments, the training data 410 may include generated images from an image generation model (e.g., image generation model 320), to provide consistency on image scoring during subsequent refinement of that image generation model. The training data 410 may include image scores associated with user engagement of the generated images from the image generation model. As a non-limiting example, user engagement data may include user selection, saving, downloading, and the like, of specific generated images from multiple options provided from the same prompt.

In some embodiments, the training data 410 may include pre-selected images, including but not limited to images from a stock image database and usage data of those images, or images from a social media platform and engagement data of those images.

In some embodiments, the training data 410 may include a set of images with limited or no associated image scores. Additional image scores may be generated from analysis of the images to determine technical image properties, intrinsic image properties, or other image properties.

In some embodiments, the third stage is to refine the image generation model. Training of the image generation model may be refined with image scores, to generate images with higher scores. The image scores may be associated with the training data (pre-scored), may be provided using an image scoring model that is trained as described above with respect to the second stage, or provided using a pre-trained image scoring model.

In some embodiments, the refinement process includes an optimization of a pre-trained image generator leveraging a pre-trained image scoring model as supervision. The image generation model may be optimized and/or conditioned to generate images that the image scoring model scores highly. During the refinement process, an input text prompt is passed to the generator, which generates a set of images aligned with that prompt. The image scoring model scores and ranks the generated images, and the image generation model is fine-tuned to shift generations towards the highest scoring image, i.e., to push image generation output towards images that will get high scores from the image scoring model.

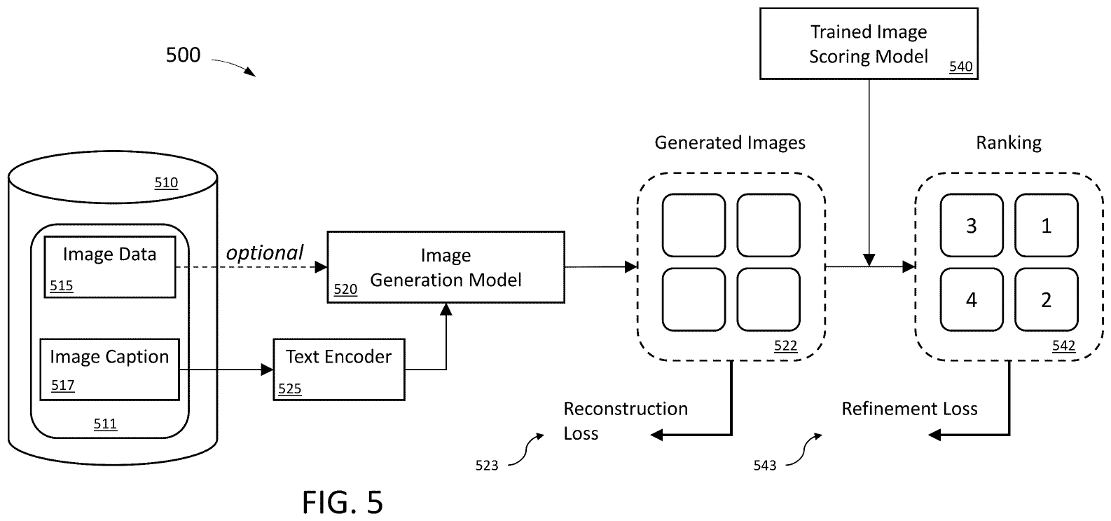

FIG. 5 is a block diagram that illustrates a training pipeline 500 for refining an image scoring model, according to some embodiments. Refining the model may also be referred to as fine-tuning the model. The training pipeline 500 is similar to the embodiment of the training pipeline 300 and the training pipeline 400 discussed above with respect to FIG. 3 and FIG. 4, respectively, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

In the example of FIG. 5, the training pipeline 500 uses general training data 510 having multiple training images, of which an exemplary training image 511 is shown in more detail. The training image 511 includes image data 515 and an associated image caption 517. The image caption 517 may be stored as metadata tags (e.g., as entries within a header structure) of the image data 515, stored alongside the image data 515 in a same storage, or retrieved from an external database (e.g., database 152, according to some embodiments).

The general training data 510 may be used to train and/or refine an image generation model 520. The image generation model 520 may be a baseline image generation model that has not undergone any previous iterations of training or refining, or a pre-trained image generation model that has already undergone at least one iteration of training and/or conditioning.

Using at least the image caption 517 as an input, the image generation model 520 outputs one or more generated images 522, which are then compared to the ground truth (e.g., image data 515) using a loss function (not shown). In various embodiments, during refinement, input images may or may not be input to the image generation model. A reconstruction loss 523 is computed using the loss function and used to optimize the variables of the image generation model 520. This process is repeated until the reconstruction loss 523 is below a certain threshold or meets other stopping criteria (e.g., using various image-based and/or quantitative metrics).

The reconstruction loss 523 may be calculated by various methods, including but not limited to image subtraction in pixel space, a vector difference in a vector representation space, a matrix difference, and the like. The training/refining process optimizes the image generation model 520 to generate target images based on an image prompt (corresponding to image captions such as image caption 517). In some embodiments, the image generation model 520 may be conditioned on different and/or additional types of information, i.e., a sketch, another image, etc., during the current training/refining process, an earlier training process, or combination thereof.

The image captions may need to be encoded and/or embedded so that it can be consumed by the image generation model being trained and/or refined. In some embodiments, as illustrated with the example of FIG. 5, the image captions may be encoded using a text encoder 525. As a non-limiting example, the text encoder 525 may be a large language model.

The image generation model 520 may be one of a Generative Adversarial Network (GAN), a Variational Autoencoder (VAE), an autoregressive model, a diffusion-based model, a transformer-based architecture, or other type of generative model. The image generation model 520 may be a generative model of a different modality, such as a video generation model. Furthermore, the image generation model 520 may already be optimized and/or conditioned to various features in the general training data 510.

In the example embodiment shown in FIG. 5, during training, the image generation model is configured to generate four different output generated images 522 (though in practice a single image or any number of images may be generated). A trained image scoring model 540 is used to rank the generated images 522 in terms of image quality, resulting in ranked output 542. The ranked output images 542 and their scores may be provided as training data (e.g., as a new training data set) back to the image generation model 520 for further refinement of the training of the image generation model. The image generation model 520 may thus be further optimized to predict the output image that has the highest rank.

In some embodiments, only a single output image may be generated and scored, and that scoring used to further optimize the image generation model.

The ranked output images 542 may be compared to ground truth (generated images 522 and their scores from the trained image scoring model 540) using a loss function (not shown). In some embodiments, a refinement loss 543 may be computed using the loss function and used to further optimize the variables of the image generation model 520. This training process may be repeated until the refinement loss 543 is below a certain threshold or meets other stopping criteria (e.g., using various image-based and/or quantitative metrics).

In various embodiments, during refinement, image reconstruction optimization may or may not be continued in parallel to refinement optimization.

In various embodiments, during refinement, different amounts of images may be generated, scored and ranked.

In various embodiments, during refinement, the model may be tweaked to generate high scoring images in different ways. Examples include, but are not limited to, tweaking the model to always generate images that are similar to the high scoring images, to generate a set of highest scoring images, or to generate images with a score over a given threshold.

In some embodiments, during refinement, the gradients to upgrade the generative model may be back-propagated from the scoring model.

The example shown in FIG. 5 has image generation conditioned to a text input (and an optional image input). However, as described above, in other embodiments the refined image generation model 520 may also apply to implementations where the image generation is not conditioned to a text input, but to a different type of conditioning.

In some embodiments, training and refinement of the image generation model 520 may occur as a single process, where the refinement loss 543 is used to optimize the image generation model 520. In such embodiments, each training iteration generates a single batch output of generated images which are used to calculate the refinement loss 543 using a loss function. In some such embodiments, the refinement loss 543 includes the reconstruction loss 523.

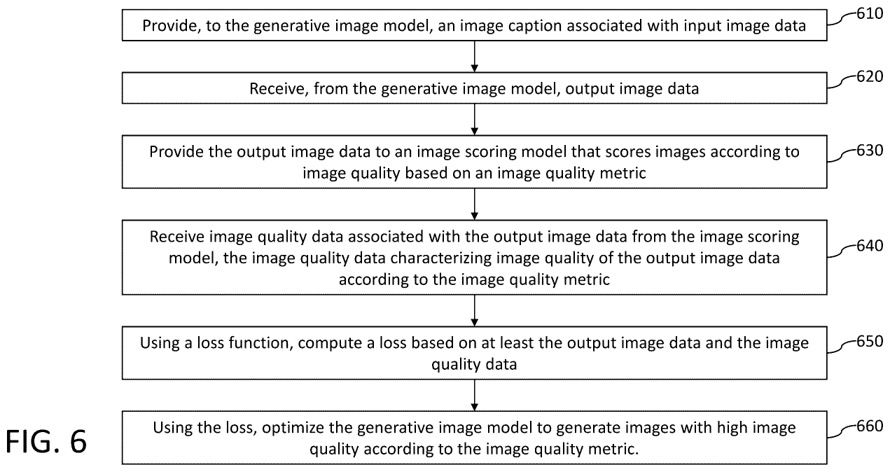

FIG. 6 is a flowchart illustrating a process 600 for training a generative image model performed by a client device (e.g., client device 110-1, etc.) and/or a client server (e.g., server 130-1, etc.), according to some embodiments. In some embodiments, one or more operations in process 600 may be performed by a processor circuit (e.g., processors 205, etc.) executing instructions stored in a memory circuit (e.g., memories 220, etc.) of a system (e.g., system 200, etc.) as disclosed herein. For example, operations in process 600 may be performed by image generation application 241, image generation engine 242, training module 252, or some combination thereof. Moreover, in some embodiments, a process consistent with this disclosure may include at least operations in process 600 performed in a different order, simultaneously, quasi-simultaneously, or overlapping in time.

In some embodiments, the generative image model is one of a Generative Adversarial Network (GAN), a Variational Autoencoder (VAE), an autoregressive model, a diffusion model, a transformer-based architecture, and the like.

At 610, the process 600 provides, to the generative image model, an image caption associated with input image data. In some embodiments, the process 600 further provides the input image data to the generative image model.

At 620, the process 600 receives, from the generative image model, output image data.

At 630, the process 600 provides the output image data to an image scoring model that scores images according to image quality based on an image quality metric.

In some embodiments, the image quality metric is computed from engagement data of images from a social media platform. The engagement data may include, but is not limited to, clicks, views, likes, saves, downloads, favorites, shares, and remixes.

In some embodiments, the image quality metric is computed from usage data of images from a stock image database. The usage data may include, but is not limited to, searches, views, favorites, saves, downloads, purchases, and resolutions.

At 640, the process 600 receives image quality data associated with the output image data from the image scoring model. In some embodiments, the image quality data characterizes image quality of the output image data according to the image quality metric.

In some embodiments, the output image data includes multiple output images, and the image quality data includes a ranking of the output images according to the image quality metric.

In some embodiments, ranking the plurality of output images generates a group of ranked images, and the process 600 further includes providing the ranked images as training data to the generative image model for performing a training process on the generative image model.

At 650, the process 600 uses a loss function to compute a loss based on at least the output image data and the image quality data. In some embodiments, the loss is computed further based on the input image data.

In some embodiments, the loss includes a reconstruction loss that is computed based on the output image data. In some embodiments, the loss includes a refinement loss that is computed based on the image quality data.

At 660, the process 600 uses the loss to optimize the generative image model to generate images with high image quality according to the image quality metric.

In some embodiments, the image scoring model if a pre-trained image scoring model. In some embodiments, the process 600 further includes receiving scoring training data that includes a group of images and a corresponding group of image scores. The process 600 may further include performing a training process using the scoring training data to train the image scoring model.

In some embodiments, the generative image model is a pre-trained generative image model. In some embodiments, the process 600 further includes receiving image training data that includes a group of images and a corresponding group of image captions. The process 600 may further include performing a training process using the image training data to train and/or refine the generative image model.

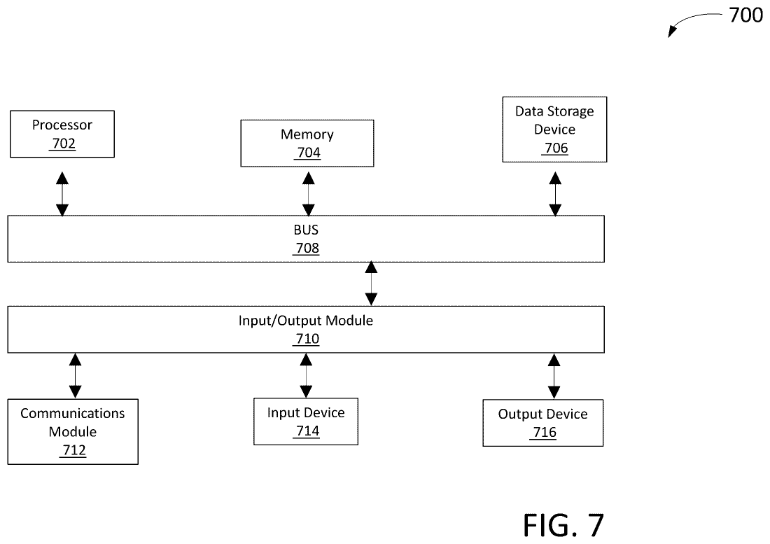

FIG. 7 is a block diagram illustrating an exemplary computer system 700 with which aspects of the subject technology can be implemented. In certain aspects, the computer system 700 may be implemented using hardware or a combination of software and hardware, either in a dedicated server, integrated into another entity, or distributed across multiple entities. As a non-limiting example, the computer system 700 may be one or more of the servers 130 and/or the client devices 110.

Computer system 700 includes a bus 708 or other communication mechanism for communicating information, and a processor 702 coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, i.e., one or more modules of computer program instructions encoded on a computer-readable medium for execution by, or to control the operation of, the computer system 700, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. The input/output module 710 can be any input/output module. Exemplary input/output modules 710 include data ports such as USB ports. The input/output module 710 is configured to connect to a communications module 712. Exemplary communications modules 712 include networking interface cards, such as Ethernet cards and modems. In certain aspects, the input/output module 710 is configured to connect to a plurality of devices, such as an input device 714 and/or an output device 716. Exemplary input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 716 include display devices such as an LCD (liquid crystal display) monitor, for displaying information to the user.

The above-described embodiments may be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in the main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires that comprise bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 700 reads application data and provides an application, information may be read from the application data and stored in a memory device, such as the memory 704. Additionally, data from the memory 704 servers accessed via a network, the bus 708, or the data storage 706 may be read and loaded into the memory 704. Although data is described as being found in the memory 704, it will be understood that data does not have to be stored in the memory 704 and may be stored in other memory accessible to the processor 702 or distributed among several media, such as the data storage 706.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In some embodiments, the computer-readable media is non-transitory computer-readable media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A method for training a generative image model, comprising:
providing, to the generative image model, an image caption associated with input image data;
receiving, from the generative image model, output image data;
providing the output image data to an image scoring model that scores images according to image quality based on an image quality metric;
receiving image quality data associated with the output image data from the image scoring model, the image quality data characterizing image quality of the output image data according to the image quality metric;
using a loss function, computing a loss based on at least the output image data and the image quality data; and
using the loss, optimizing the generative image model to generate images with high image quality according to the image quality metric.

2. The method of claim 1, wherein the loss comprises a reconstruction loss that is computed based on the output image data, and the loss further comprises a refinement loss that is computed based on the image quality data.

3. The method of claim 1, wherein the output image data comprises a plurality of output images, and the image quality data comprises a ranking of the plurality of output images according to the image quality metric.

4. The method of claim 3, wherein ranking the plurality of output images generates a plurality of ranked images, the method further comprising providing the plurality of ranked images as training data to the generative image model for performing a training process on the generative image model.

5. The method of claim 1, further comprising:
providing the input image data to the generative image model,
wherein the loss is computed further based on the input image data.

6. The method of claim 1, further comprising:
receiving scoring training data comprising a plurality of images and a corresponding plurality of image scores; and
performing a training process using the scoring training data to train the image scoring model.

7. The method of claim 1, further comprising:
receiving image training data comprising a plurality of images and a corresponding plurality of image captions; and
performing a training process using the image training data to train the generative image model.

8. The method of claim 1, wherein the image quality metric is computed from engagement data of images from a social media platform, the engagement data comprising clicks, views, likes, saves, downloads, favorites, shares, and remixes.

9. The method of claim 1, wherein the image quality metric is computed from usage data of images from a stock image database, the usage data comprising searches, views, favorites, saves, downloads, purchases, and resolutions.

10. The method of claim 1, wherein the generative image model is one of a Generative Adversarial Network (GAN), a Variational Autoencoder (VAE), an autoregressive model, a diffusion model, and a transformer-based architecture.

11. A non-transitory computer-readable medium storing a program for training a generative image model, which when executed by a computer, configures the computer to:
provide, to the generative image model, an image caption associated with input image data;
receive, from the generative image model, output image data;
provide the output image data to an image scoring model that scores images according to image quality based on an image quality metric;
receive image quality data associated with the output image data from the image scoring model, the image quality data characterizing image quality of the output image data according to the image quality metric;
using a loss function, compute a loss based on at least the output image data and the image quality data; and
using the loss, optimize the generative image model to generate images with high image quality according to the image quality metric.

12. The non-transitory computer-readable medium of claim 11, wherein the loss comprises a reconstruction loss that is computed based on the output image data, and the loss further comprises a refinement loss that is computed based on the image quality data.

13. The non-transitory computer-readable medium of claim 11, wherein the output image data comprises a plurality of output images, and the image quality data comprises a ranking of the plurality of output images according to the image quality metric.

14. The non-transitory computer-readable medium of claim 13, wherein ranking the plurality of output images generates a plurality of ranked images, and the program, when executed by the computer, further configures the computer to provide the plurality of ranked images as training data to the generative image model for performing a training process on the generative image model.

15. The non-transitory computer-readable medium of claim 11, wherein the program, when executed by the computer, further configures the computer to provide the input image data to the generative image model, wherein the loss is computed further based on the input image data.

16. The non-transitory computer-readable medium of claim 11, wherein the program, when executed by the computer, further configures the computer to:
receive scoring training data comprising a plurality of images and a corresponding plurality of image scores; and
perform a training process using the scoring training data to train the image scoring model.

17. The non-transitory computer-readable medium of claim 11, wherein the program, when executed by the computer, further configures the computer to:
receive image training data comprising a plurality of images and a corresponding plurality of image captions; and
perform a training process using the image training data to train the generative image model.

18. The non-transitory computer-readable medium of claim 11, wherein the image quality metric is computed from engagement data of images from a social media platform, the engagement data comprising clicks, views, likes, saves, downloads, favorites, shares, and remixes.

19. The non-transitory computer-readable medium of claim 11, wherein the image quality metric is computed from usage data of images from a stock image database, the usage data comprising searches, views, favorites, saves, downloads, purchases, and resolutions.

20. A system for training a generative image model, comprising:
a processor; and
a non-transitory computer readable medium storing a set of instructions, which when executed by the processor, configure the system to:
provide, to the generative image model, an image caption associated with input image data;
receive, from the generative image model, output image data;
provide the output image data to an image scoring model that scores images according to image quality based on an image quality metric;
receive image quality data associated with the output image data from the image scoring model, the image quality data characterizing image quality of the output image data according to the image quality metric;
using a loss function, compute a loss based on at least the output image data and the image quality data; and
using the loss, optimize the generative image model to generate images with high image quality according to the image quality metric.
